(19) United States
(12) Patent Application Publication
(10) Pub. No.: US 2005/0209928 A1
(43) Pub. Date: Sep. 22, 2005

(54) System and method for processing e-commerce transactions

(76) Inventor: Michael Willoughby, Celina, TX (US)

Correspondence Address: Wolff & Samson PC, One Boland Drive, West Orange, NJ, 07052, US

(21) Appl. No.: 10/804,465

(22) Filed: Mar. 19, 2004

(51) Int. Cl. G06F 17/60

(52) U.S. Cl. 705/26

(57) ABSTRACT

A system and method for processing e-commerce transactions on an IBM server, such as an iSeries or AS/400 computing system, is provided. XML-encoded e-commerce transactions are submitted via the Internet to a central e-commerce website server, from one or more requesters. The website server dispatches the XML transactions to an IBM server for processing thereby. Optionally, the e-commerce server can process the XML transactions in accordance with one or more pre-defined business rules. The XML transactions are received by the IBM server, and are translated thereby to one or more data structures and/or formats compatible with the IBM server. A server program on the IBM server parses the transaction, determines its type, and calls a handler program for handling the transaction. The handler program subsequently calls one or more customizable subroutines containing programmer-modified code for handling the transaction. Additionally, external applications can operate on the transaction. The processed transactions are then translated back to an XML format, and the results of processing dispatched back to the requester via the e-commerce website.

### BACKGROUND OF THE INVENTION

1. Field of the Invention

The present invention relates to a system and method for processing electronic commerce (e-commerce) transactions. More specifically, the invention relates to a system and method for processing Extensible Markup Language (XML) e-commerce transactions using a proprietary computing system, such as an IBM iSeries or AS/400 server.

2. Related Art

In the business world, proprietary computing systems are often used to store and manage enterprise data. Such systems are proprietary in that they include both hardware and software provided by a single manufacturer. For example, many organizations utilize mainframe-class computing hardware manufactured by International Business Machines (IBM), running one or more proprietary IBM operating systems such as VM/ESA. Further, smaller organizations also often utilize proprietary computing systems to manage data, such as the IBM iSeries or AS/400 server.

While these proprietary computing systems are effective in handling internal data processing needs for an organization, such systems cannot easily be integrated into e-commerce environments. Some solutions have been proposed for integrating proprietary servers into e-commerce settings. However, such systems cannot gather and manage a plurality of e-commerce transactions at a simple, easy-to-use, centralized e-commerce website, and often provide only system-to-system interoperability. Moreover, such systems cannot dynamically dispatch transactions to one or more proprietary computing systems, process same on the one or more proprietary computing systems, and return the results to one or more requesters in real time, without requiring programming activity in languages that are not native to the proprietary computing systems.

The IBM iSeries and AS/400 computing systems are commonly used throughout businesses. For example, these systems are often employed in human resources, accounting, and inventory environments, where traditional terminal-mode “green screen” applications are suitable. However, these systems cannot easily be integrated into e-commerce settings, nor can they efficiently handle XML transactions submitted over the Internet.

Accordingly, what would be desirable, or has not yet been provided, is a system and method for processing e-commerce transactions wherein a plurality of e-commerce transactions are gathered at a central e-commerce website, optionally processed according to one or more business rules on the website, dispatched from the e-commerce website, processed on a proprietary computing system such as an IBM iSeries or AS/400 computing system, and the results gathered and dispatched to one or more transaction requesters via the e-commerce website.

### SUMMARY OF THE INVENTION

The present invention provides a system and method for processing e-commerce transactions. A plurality of e-commerce transactions encoded in Extensible Markup Language (XML) format are gathered at an e-commerce website. The transactions can be processed according to one or more pre-defined business rules stored in a database on the e-commerce website server. The transactions can also be gathered at an integration point on the e-commerce website server, and translated from a standard XML format into an intermediate XML transport protocol. Thereafter, the formatted transactions are dispatched to one or more IBM iSeries or AS/400 computing systems (hereinafter, “IBM servers”) for processing thereby. After processing, the transactions are returned to requesters via the e-commerce website.

Each of the one or more IBM servers of the present invention includes a server program that processes the transactions, translating same into one or more data structures compatible with the IBM server. Further, the server program parses the transaction to determine a transaction type, and retrieves a handler program from a customizable routing table to handle the transaction. The server program calls the handler program, which verifies the transaction type and calls one or more customizable subroutines on the proprietary computing system for executing the transaction. Programmer-modified code on the computing system can be utilized during execution of the transaction. Additionally, one or more external applications stored on the IBM server or on other local or remote servers can be called by the customizable subroutine during execution. After execution, results are gathered by the server program and are encoded into an intermediate XML transport protocol. Thereafter, the encoded results are dispatched to the e-commerce website, where they are formatted into a standard XML format and may be processed on the website before being returned to the requester. A plurality of transactions can be handled by the server program in such manner.

The present invention also provides a method for processing a plurality of e-commerce transactions using one or more IBM servers. The method comprises the steps of gathering one or more XML-formatted e-commerce transactions at a central website, optionally processing the transactions on the website according to one or more business rules and updating a database on the website, translating the standard XML-formatted transactions into an intermediate XML transport protocol, dynamically dispatching the formatted transactions to one or more available IBM servers, receiving the transactions at the IBM server, translating the transactions into one or more data structures compatible with the IBM server, and processing the data structures on the computing system or, optionally, on other local or remote systems. Further, the method comprises gathering results of processing, translating the results into an intermediate XML transport protocol, dispatching the results to the e-commerce website, formatting the results into XML, and transmitting the formatted results to the transaction requester.

The present invention further provides a method for processing an XML transaction on a proprietary computing system. The method comprises the steps of receiving an XML transaction at a central website; transmitting the transaction to a proprietary computing system; receiving the transaction at the proprietary computing system; parsing the transaction on the proprietary computing system to determine a transaction type; querying a router table using the transaction type; retrieving a handler program from the router table based upon the transaction type; executing the handler program; calling a customizable subroutine from the handler program; creating a data structure based upon the transaction type and compatible with the proprietary computing system; loading data from the transaction into the data structure for execution by one or more local or remote applications; executing the one or more local or remote applications from the customizable subroutine using data in the data structure; storing results of execution in the data structure; creating an XML response that includes the results of execution extracted from the data structure; and passing the XML response to a transaction requester via the central website.

### BRIEF DESCRIPTION OF THE DRAWINGS

Other important objects and features of the invention will be apparent from the following Detailed Description of the Invention taken in connection with the accompanying drawings in which:

FIG. 1 is a diagram showing the overall system architecture of the present invention.

FIG. 2 is a flowchart showing overall transaction processing logic achieved by the present invention.

FIG. 3 is a flowchart showing processing logic of the e-commerce website server program of the present invention in greater detail.

FIG. 4 is a flowchart showing processing logic of the integration point of the e-commerce website server of the present invention in greater detail.

FIGS. 5 and 6 are flowcharts showing processing logic of the IBM server program of the present invention in greater detail.

### DETAILED DESCRIPTION OF THE INVENTION

The present invention relates to a system and method for processing e-commerce transactions on an IBM iSeries or AS/400 computing system (referred to herein collectively as “IBM server” or “IBM servers”). XML transactions originating from one or more requesters are transmitted via the Internet to a central e-commerce website, and are gathered thereat. The e-commerce transactions are formatted in an XML format that is native to the website server, and can be processed according to pre-defined business rules stored on the website server. Before and after processing and updating a database on the website server, the transactions can be translated into an intermediate XML transport protocol format and dispatched to an IBM server for processing. The IBM server includes a server program that receives the transactions, translates same into one or more data structures compatible with the computing system, and processes the transactions. The transactions can be executed using one or more customizable subroutines, and optionally, programmer-modified code and/or external applications. The results of processing are gathered by the server program, translated into an intermediate XML transport protocol, and are dispatched to the e-commerce website. Thereafter, the results are re-encoded into standard XML format, and are returned to the transaction requester.

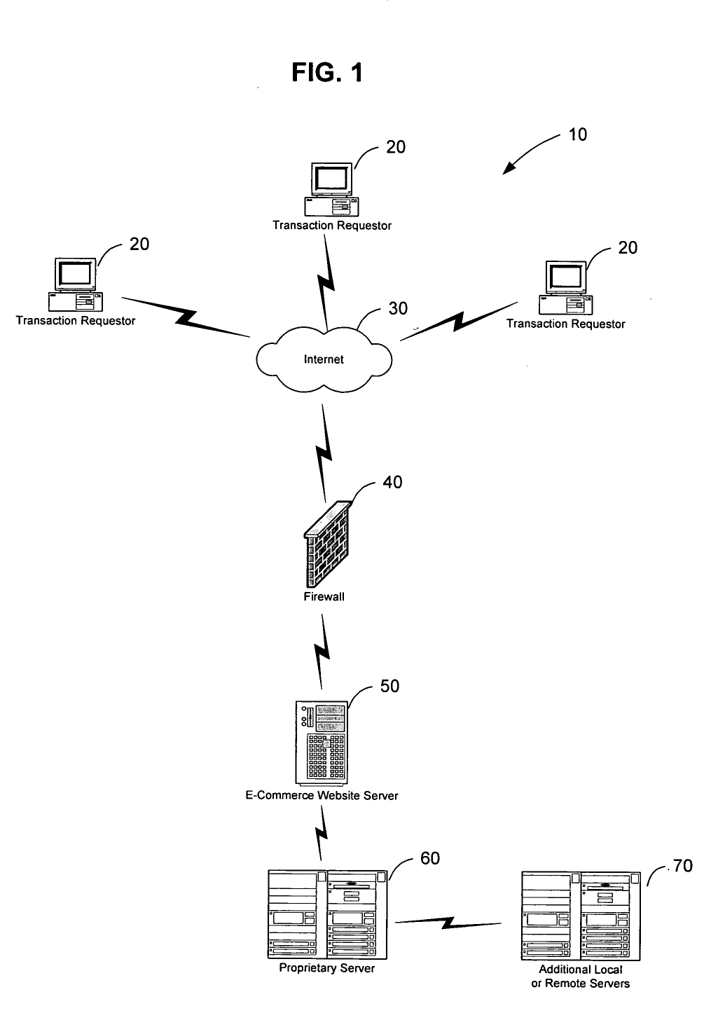

FIG. 1 is a diagram showing the overall system architecture of the present invention, indicated generally at 10. One or more XML-encoded transactions can be submitted at one or more computing systems 20 operated by one or more transaction requesters. The computer systems 20 are preferably personal computers operating a standard web browser in communication with the Internet 30, wherein transaction information is submitted via such browsers. However, the transactions can be submitted from any desired computing system, such as an enterprise data processing system connected to the Internet via a high-speed digital communications link. The XML-encoded transactions are transmitted to the Internet 30, and optionally, to a firewall 40, to e-commerce website server 50. Both the e-commerce website server 50 and proprietary server 60 contain software and embodying the process and logic of the present invention.

In a preferred embodiment of the present invention, the proprietary server 60 comprises an IBM server such as the IBM iSeries or AS/400 mainframe-class computing system, running a proprietary operating system, such as OS/400 or other similar operating system, and the website server 50 comprises an IBM X345 or better server configured and compatible with Windows 2003 and Microsoft Internet Information Server (IIS). Other types of computing equipment can be substituted for servers 50 and 60 without departing from the spirit or scope of the present invention.

The e-commerce website server 50 gathers one or more XML-encoded transactions and, optionally, can process the transactions according to one or more pre-defined business rules and update a database on the website server. Before and after processing by the website server 50, the website server 50 can translate the transactions into an intermediate XML transport protocol, and dispatch the transactions to proprietary server 60 for processing thereby. The server 60 includes a server program that translates the transactions into one or more data structures compatible with the server 60. Further, the server program parses the transaction to determine its type, and calls one or more customizable subroutines for executing the transaction. External applications existing on the server 60 or on other local or remote servers 70 can also be executed by the present invention. The results of transaction processing carried out by the server 60 are then dispatched to the website server 50, wherein the results are then translated into a standard XML format. The XML-encoded results are then submitted to one or more of the transaction requesters 20, thereby completing transaction processing.

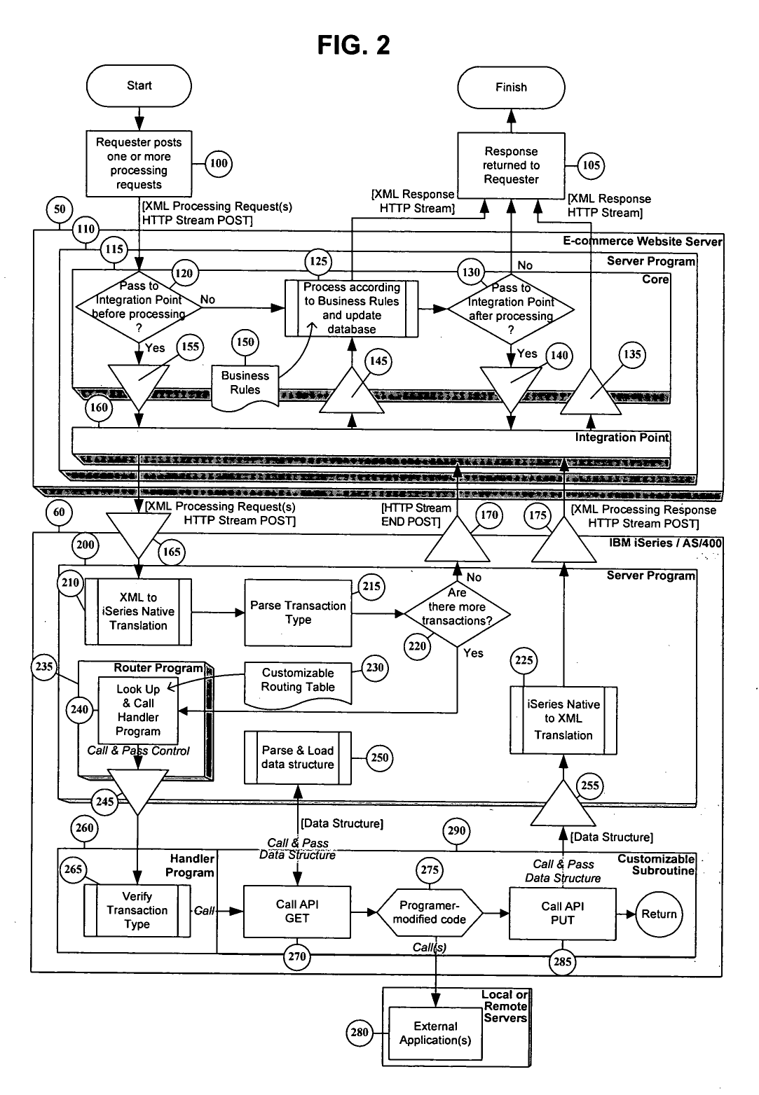

FIG. 2 is a flowchart showing the overall process and logic achieved by the present invention. Customized software components installed on both the website server 50 and one or more IBM servers 60 allow the present invention to process a plurality of transactions. These software components can be coded in any suitable high level language. Beginning in step 100, a transaction requester posts one or more processing requests over the Internet to the e-commerce website server 50 using an XML processing request that is transmitted to the e-commerce website server 50 via an HTTP stream POST operation. A server program 110 comprising a core component 115 and an integration point component 160 receives the XML processing request. In step 120, a determination is made as to whether to pass the processing request to the integration point 160. If a positive determination is made, the processing request is passed to the integration point 160. If a negative determination is made, step 120 invokes step 125, wherein the XML request is processed according to one or more pre-defined business rules 150.

The business rules 150 can be stored in one or more databases existent on the website server 50. Such business rules could comprise, for example, adding, deleting, or changing objects in the database such as orders, categories, or item descriptions. Thereafter, step 125 invokes step 130 wherein a determination is made as to whether to pass the processing request to the integration point 160. If a negative determination is made, step 130 invokes step 105, wherein the processed XML request is returned to the transaction requester via an XML response transmitted by an HTTP stream. If a positive determination is made in step 130, the processed XML request is passed to the integration point 160 via procedure call 140.

The integration point 160 on the e-commerce website server 50 allows one or more XML-formatted requests to be gathered and managed thereby. Such requests could originate from a multitude of requesters and could be transmitted to the website 50 over the Internet or by any other suitable digital communications link. The integration point 160 translates the transactions from an XML format that is native to the website 50 into an intermediate XML transport protocol that is compatible with the server program 200 of the server 60. The integration point dynamically dispatches the translated XML processing requests by an HTTP POST operation to one or more of the IBM servers 60 for processing thereby.

The IBM server 60 includes the server program 200, one or more handler programs 260, and one or more customizable subroutines 290. Additionally, the computing system 60 can access one or more optional external applications 280. The server program 200 comprises a number of components that allow each XML request to be translated into one or more data structures and/or formats compatible with the computing system 60. In step 210, an XML to native format translation procedure is invoked. This procedure parses an XML-formatted request into one or more formats that are compatible with the server program 200, as will be discussed later in greater detail.

After translation, the server program invokes step 215, wherein the transaction is read to determine its type. Examples of various transaction types include, but are not limited to, items, orders, catalogs, customer information, addresses, notes, and other types of information. Then, step 220 is invoked, wherein a determination is made as to whether there are more transactions. If a negative determination is made, an HTTP End Post stream is transmitted to the integration point 160 via procedure call 170. If a positive determination is made, the server program invokes router program 235. The transaction type determined in step 215 is utilized as a look up key by lookup procedure 240 into a customizable routing table 230 to retrieve a handler program 260 to handle the transaction. The customizable routing table 230 can contain a multitude of entries corresponding to a plurality of separate handler programs, each of which can be custom-tailored to handle various transaction types. Once retrieved, the handler program 260 is called in step 240, and initiated via procedure call 245.

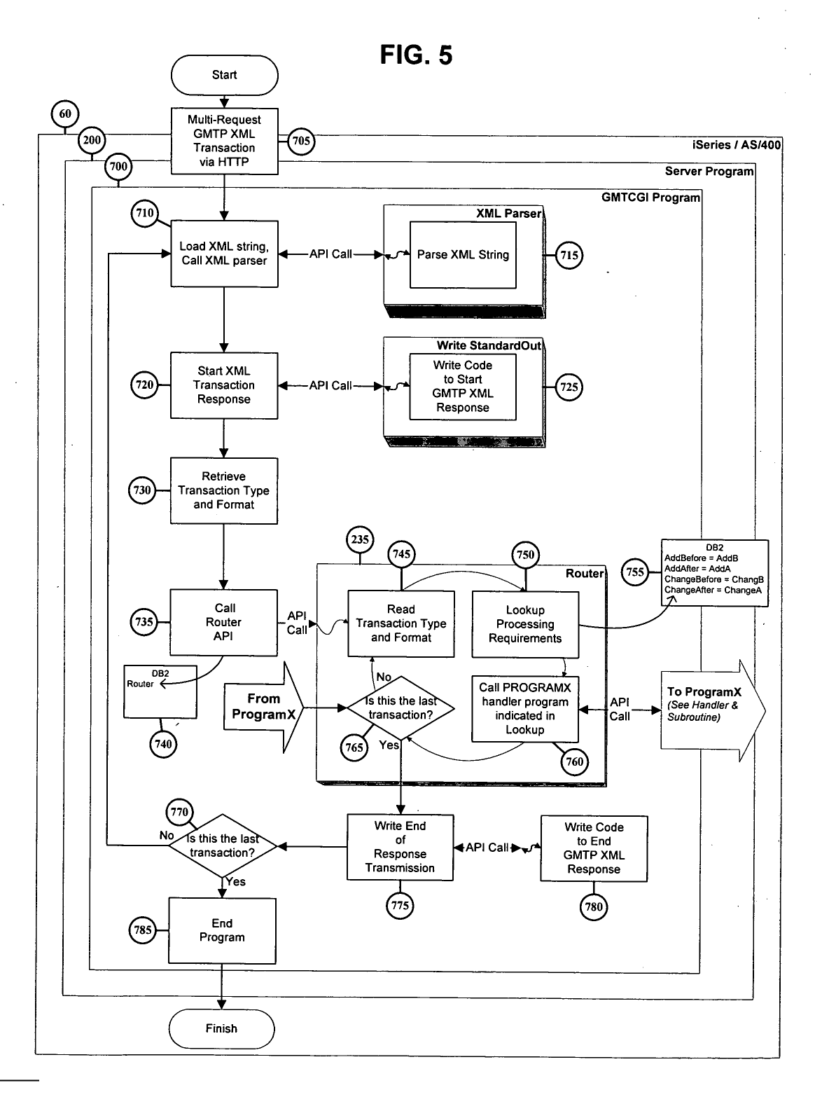

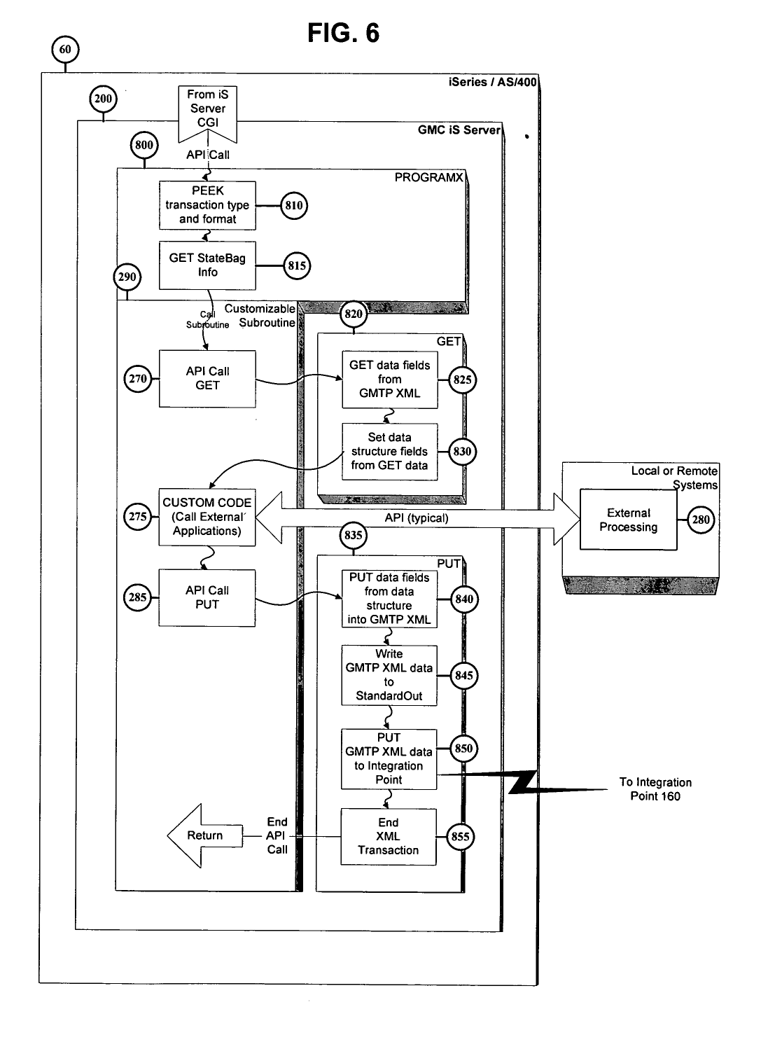

In step 265 of the handler program 260, the transaction type is verified. Thereafter, the handler program calls one or more customizable subroutines 290 to process the transaction. The customizable subroutine 290 can be pre-defined and/or modified by a programmer. The customizable subroutine 290 interacts with the data and in step 270, an Application Programmer Interface (API) GET call is performed, wherein the server program 200 parses the transaction data and loads it in step 250 into an externally-defined data structure compatible with the IBM server 60. In a preferred embodiment, the data structure has a format that is common to RPG and COBOL programs existent on the IBM server 60 or one or more local or remote systems connected thereto. This data structure is capable of being processed by programmer-modified code 275 and external applications 280. The customizable subroutine 290 can pass the data structure loaded in step 250 to the programmer-modified code 275 for manipulation thereby. Additionally, the programmer-modified code 275 can interact with one or more external applications 280 to provide added functionality. Such external applications 280 could comprise one or more applications external to the computing system 60 or located thereon. After processing, step 285 is invoked, wherein an API PUT procedure is called. The procedure 285 then passes the modified data structure to XML translation module 225 of the server program 200 via procedure call 255. At that point, the customizable subroutine has completed processing the one or more data structures. Importantly, the XML to native data structure and native data structure to XML translation achieved by the server program 200 of the present invention allow XML-formatted data to be used interoperably with the IBM server 60 and one or more local or remote servers connected thereto. Such translation will be described in greater detail with reference to FIGS. 5 and 6, discussed below.

In step 225, the processed data structure is translated into an intermediate XML transport protocol and transmitted back to the integration point 160 via procedure call 175. The integration point 160 then dispatches the results of processing to the requester in step 105 via procedure call 135. Further, the integration point 160 could forward the processed transaction for further processing by the business rules 150 of the server program 110. This could be achieved by forwarding the results of processing to procedure 125, discussed earlier, via procedure call 145. As can be readily appreciated, the e-commerce transaction is thereby fully processed, and is returned to a transaction requester for review. Further, additional transactions can be received by the present invention, and processed in accordance with the procedures discussed herein.

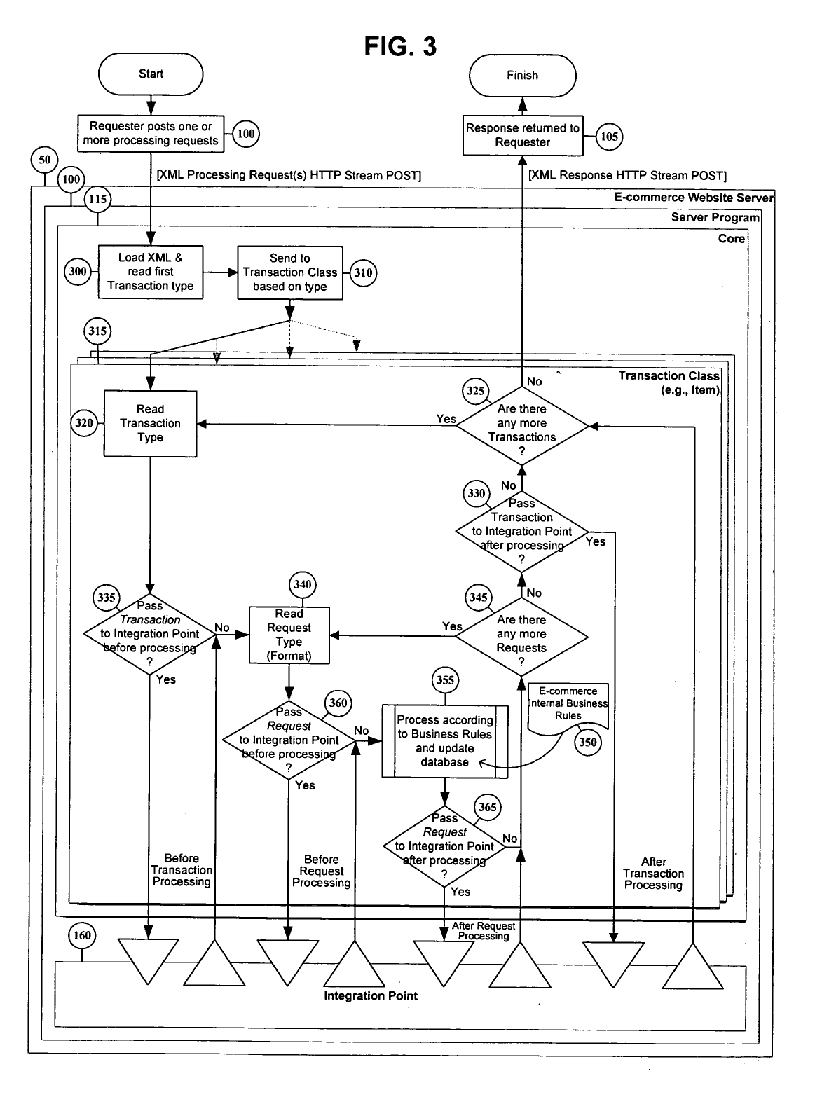

FIG. 3 is a flowchart showing processing logic of the core component 115 of the server program 100 of the e-commerce website server 50 of the present invention in greater detail. In step 300, when an XML transaction has been received from one or more requesters, the type of the transaction is read. Then, step 310 is invoked, wherein the transaction is sent to one or more transaction classes 315 for processing, based upon the transaction type. Each of the transaction classes 315 can be customized to process various transactions according to type.

In step 320, the transaction type is read. Then, in step 335, a determination is made as to whether to pass the transaction to the integration point 160 before processing the transaction. If a positive determination is made, the transaction is passed to integration point 160. If a negative determination is made, or after a transaction has been processed by the integration point 160, step 340 is invoked, wherein the request type of the transaction is read. Then, step 360 is invoked, wherein a determination is made as to whether to pass the request to the integration point 160. If a positive determination is made, the request is passed to the integration point 160. If a negative determination is made, or after a request has been processed by the integration point 160, step 355 is invoked, wherein the transaction is processed in accordance with one or more business rules 350. Then, in step 365, a determination is made as to whether to pass the request to the integration point after processing. If a positive determination is made, the request is passed to the integration point 160. If a negative determination is made, or after a request has been processed by the integration point 160, step 345 is invoked.

In step 345, a determination is made as to whether there are any additional requests that require processing for the current transaction. If a positive determination is made, step 340 is invoked, so that additional requests can be processed. If a negative determination is made, step 330 is invoked, wherein a determination is made as to whether to pass the transaction to the integration point 160 after processing. If a positive determination is made, the transaction is passed to the integration point 160. If a negative determination is made, or when a transaction has been processed by the integration point 160, step 325 is invoked. In step 325, a determination is made as to whether there are any additional transactions to be processed. If a positive determination is made, step 320 is invoked so that such transactions can be processed. If a negative determination is made, results of processing are passed back to the requester in step 105.

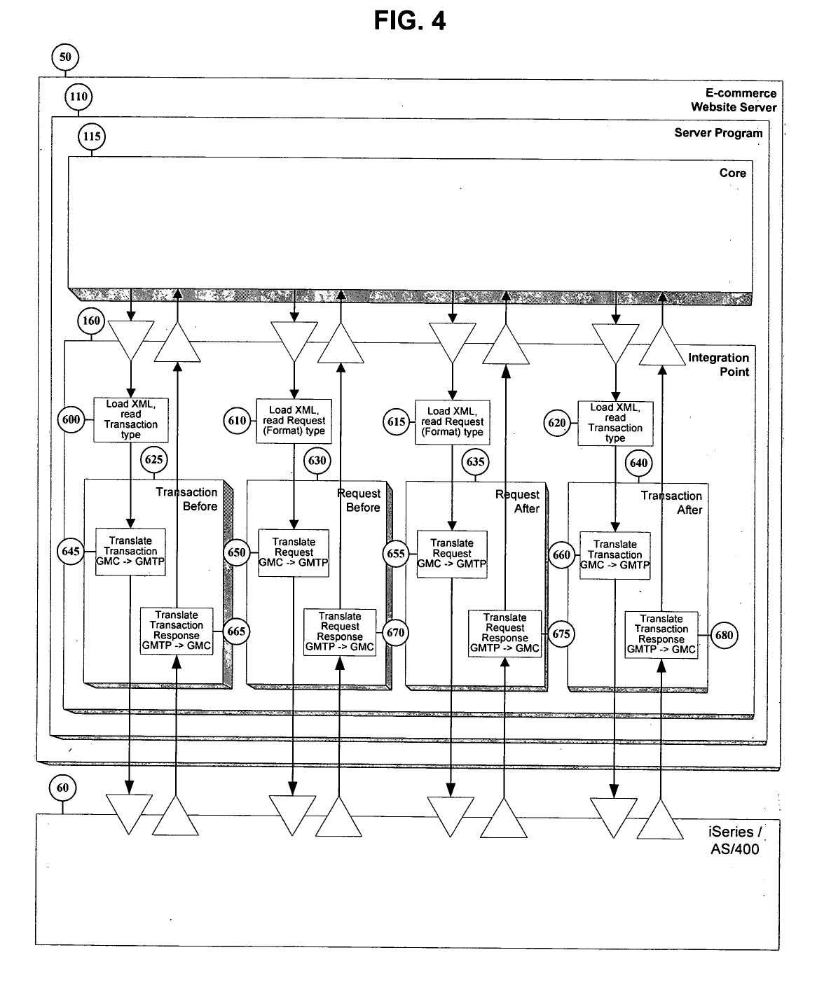

FIG. 4 is a flowchart showing processing logic of the integration point 160 of the server program 110 of the website server 50 of the present invention in greater detail. The integration point 160 comprises translation modules 625, 630, 635, and 640 that allow for XML transactions, requests, and responses (occasionally referred to as GlobalMerchant Commerceware or “GMC” XML) to be translated into an intermediate XML transport protocol (occasionally referred to as GlobalMerchant Transport Protocol or “GMTP” XML) that is compatible with the iSeries/AS/400 server 60, and vice versa. Module 625 translates transactions prior to processing by business rules. Module 630 translates requests prior to processing by business rules. Module 635 translates requests after processing by business rules. Module 640 translates transactions after processing by business rules.

Translation from a GMC XML format to a GMTP XML format can be accomplished using a MICROSOFT XML Document Object Model (DOM). To translate from GMC format to GMTP format, the integration point 160 loads the transaction into a source DOM document and determines the GMC transaction and request types. Then the integration point 160 loads a style sheet that is specified for the current transaction and request type into an Extensible Stylesheet Language (XSL) map DOM document. Thereafter, the integration point 160 commands a Microsoft transform node to transform the source DOM document to an output DOM document using the XSL map DOM document. The transform node then creates an output DOM document that corresponds to a GMTP-formatted XML transaction, which conforms to style requirements of the IBM server 60 including length, capitalization, characters, etc.

Translation from GMTP-formatted XML data produced by the IBM server 60 can also be achieved using an XML DOM. The integration point 160 loads GMTP-formatted XML data from the IBM server 60 into a source DOM document. Thereafter, the transaction and request types are determined, and a style sheet specified for the current transaction and request type is loaded into an XSL map DOM document. The transform node then creates an output DOM that corresponds to GMC XML, which conforms to style requirements of the e-commerce website server 50, such as length, capitalization, characters, etc.

In step 600, a GMC XML transaction is loaded, and the transaction type read. The transaction is then passed to module 625, wherein procedure 645 translates the transaction to GMTP XML format. Thereafter, the GMTP XML-formatted transaction is sent to the IBM server 60 for processing. One or more processing responses generated by server 60 are then received by process 665. Process 665 translates the GMTP XML-formatted response into GMC XML format, which is then transmitted back to the core component 115 of the server program 110.

In step 610, a GMC XML request is loaded, and the request type read. The request is then passed to module 630, wherein procedure 650 translates the request to GMTP XML format. Thereafter, the GMTP XML-formatted request is sent to iSeries/AS/400 server 60 for processing. One or more processing responses generated by server 60 are then received by process 670. Process 670 translates the GMTP XML-formatted response into GMC XML format, which is then transmitted back to the core component 115 of the server program 110.

In step 615, a GMC XML request is loaded, and the request type read. The request is then passed to module 635, wherein procedure 655 translates the request to GMTP XML format. Thereafter, the GMTP XML-formatted request is sent to iSeries/AS/400 server 60 for processing. One or more processing responses generated by server 60 are then received by process 675. Process 675 translates the GMTP XML-formatted response into GMC XML format, which is then transmitted back to the core component 115 of the server program 110.

In step 620, a GMC XML transaction is loaded, and the transaction type read. The transaction is then passed to module 640, wherein procedure 660 translates the transaction to GMTP XML format. Thereafter, the GMTP XML-formatted request is sent to the IBM server 60 for processing. One or more processing responses generated by server 60 are then received by process 680. Process 680 translates the GMTP XML-formatted response into GMC XML format, which is then transmitted back to the core component 115 of the server program 110.

A sample GMC XML code portion is shown below:

TABLE 1
<?xml version=“1.0” encoding=“UTF-8” ?>
- <GMTX Type=“Request”>

- <GMStateBag>

<ExitURL>http://190.1.1.1:6881/gm/gmtcgl.asp</ExitURL>
<ExitDLL>Core_CommerceWareExit</ExitDLL>
<UserID Type=“Integer”>75294</UserID>
<ClientID Type=“Integer”>17</ClientID>
<UserName Type=“VarChar”>CommerceWareDefault</UserName>
<Password Type=“VarChar”>7D32E8313572BFEC</Password>
<Description Type=“VarChar”>CommerceWare<Description>
<UserTypeID Type=“Integer”>3</UserTypeID>
<PriceGroupID Type=“Integer” />
<LocaleID Type=“Integer”>1</LocaleID>
<CurrencyID Type=“Integer”>1</CurrencyID>
<CatalogID Type=“Integer”>45</CatalogID>
<Active Type=“Boolean”>True</Active>
<UserGroupID Type=“Integer” />
<Email Type=“VarChar” />
<SessionKey Type=“VarChar”>69CC61E9-
E6AC-44C8-906C-6AD7E3B53D3D</SessionKey>
<GeneralUseColumn1 Type=“Integer”>0</GeneralUseColumn1>
<GeneralUseColumn2 Type=“Integer”>0</GeneralUseColumn2>
<GeneralUseColumn3 Type=“Currency”>0</GeneralUseColumn3>
<GeneralUseColumn4 Type=“Currency”>0</GeneralUseColumn4>
<GeneralUseColumn5 Type=“VarChar” />
<GeneralUseColumn6 Type=“VarChar” />
<GeneralUseColumn7 Type=“VarChar” />
<GeneralUseColumn8 Type=“VarChar” />
<GeneralUseColumn9 Type=“VarChar” />
<GeneralUseColumn10 Type=“VarChar” />
<Custom1 Type=“Integer”>0</Custom1>
<Custom2 Type=“Integer”>0</Custom2>
<Custom3 Type=“Currency”>0</Custom3>
<Custom4 Type=“Currency”>0</Custom4>
<Custom5 Type=“VarChar” />
<Custom6 Type=“VarChar” />
<Custom7 Type=“VarChar” />
<Custom8 Type=“VarChar” />
<Custom9 Type=“VarChar” />
<Custom10 Type=“VarChar” />
<Date>3/18/2004</Date>
<Time>3:33:10 PM</Time>

</GMStateBag>

- <Transactions Type=“Address” Exit=“Both”>

- <Add Exit=“Both”>

<ID />
<Name>Meriadoc Brandybuck</Name>
<Attention>Merry</Attention>
<Address1>2 FarToWalk</Address1>
<Address2>TuckedIntoHill</Address2>
<Address3>UnderTheElm</Address3>
<City>Buckland</City>
<County>Brandybuck</County>
<State>The Shire</State>
<PostalCode>12345-6789</PostalCode>
<Country>Middle Earth</Country>
<Phone1>123-456-7890</Phone1>
<Phone2>123-456-7889</Phone2>
<Email>merry@buckland.net</Email>
<AttributeName />
<TableID />
<Sequence />
Prefix>Mr.</Prefix>
<FirstName>Meriadoc</FirstName>
<MiddleName>Merry</MiddleName>
<LastName>Brandybuck</LastName>
<Suffix>Esq.</Suffix>

</Add>

</Transactions>

</GMTX>

The code shown in Table 1 corresponds to a GMC XML request received by the central website 50 of the present invention. The integration point 160 translates this request into the corresponding GMTP XML request, shown below:

TABLE 2
<?xml version=“1.0” encoding=“UTF-8” ?>
- <GMTX Type=“Request”>

- <WSTATEBAG.STATEBAG>

<USERID>75294</USERID>
<CLIENTID>17</CLIENTID>
<USERNAME>CommerceWareDefault</USERNAME>
<PASSWORD>7D32E8313572BFEC</PASSWORD>
<USERDESCRIPTION>CommerceWare</
USERDESCRIPTION >
<USERTYID>3</USERTYID >
<PRICEGPID/> </PRICEGPID>
<LOCALEID>1</LOCALEID >
<CURRID>1</CURRID >
<CATALOGID>45</CATALOGID >
<ACTIVE>True</ACTIVE>
<USERGROUPID> </USERGROUPID>
<EMAIL> </EMAIL>
<SESSKEY>9C718C57-E9BA-47CD-9F17-
2C58C8E4BE1D</SESSKEY>
<GENUSE1>0</GENUSE1>
<GENUSE2>0</GENUSE2>
<GENUSE3>0</GENUSE3>
<GENUSE4>0</GENUSE4>
<GENUSE5>0</GENUSE5>
<GENUSE6>0</GENUSE6>
<GENUSE7>0</GENUSE7>
<GENUSE8>0</GENUSE8>
<GENUSE9>0</GENUSE9>
<GENUSE10>0</GENUSE10>
<CUSTOM1> </CUSTOM1>
<CUSTOM2> </CUSTOM2>
<CUSTOM3> </CUSTOM3>
<CUSTOM4> </CUSTOM4>
<CUSTOM5> </CUSTOM5>
<CUSTOM6> </CUSTOM6>
<CUSTOM7> </CUSTOM7>
<CUSTOM8> </CUSTOM8>
<CUSTOM9> </CUSTOM9>
<CUSTOM10> </CUSTOM10>
<TXNDATE>3/18/2004</TXNDATE>
<TXNTIME>3:33:11 PM</TXNTIME>

</WSTATEBAG.STATEBAG>

- <TRANSACTION>

- <WADDRESS.ADDB>

<METHODX>Both</METHODX >
<ID />
<NAME>Meriadoc Brandybuck</NAME>
<ATTENTION>Merry</ATTENTION>
<ADDRESS1>2 FarToWalk</ADDRESS1>
<ADDRESS2>TuckedIntoHill</ADDRESS2>
<ADDRESS3>UnderTheElm</ADDRESS3>
<CITY>Buckland</CITY>
<COUNTY>Brandybuck</COUNTY>
<STATE>The Shire</STATE>
<POSTAL>12345-6789</POSTAL>
<COUNTRY>Middle Earth</COUNTRY>
<PHONE1>123-456-7890</PHONE1>
<PHONE2>123-456-7889</PHONE2>
<EMAIL>merry@buckland.net</EMAIL>
<ATTRNAME />
<TABLEID />
<SEQUENCE />
<PREFIX>Mr.</PREFIX>
<FIRSTNAME>Meriadoc</FIRSTNAME>
<MIDNAME>Merry</MIDNAME>
<LASTNAME>Brandybuck</LASTNAME>
<SUFFIX>Esq.</SUFFIX>

</WADDRESS.ADDB>

</TRANSACTION>

</GMTX>

The request shown in Table 2 is in a format compatible with the server program 200 of the IBM server 60 of the present invention. As can be appreciated, the integration point 160 also allows a GMTP XML document, similar to that shown in Table 2, to be translated into GCM XML document, similar to that shown in Table 1.

FIG. 5 is a flowchart showing processing logic of the server program 200 of the IBM server 60 of the present invention in greater detail. As mentioned previously, the server program 200 contains logic for processing one or more GMTP-formatted XML transactions on the IBM server. This logic is contained in GMTCGI program 700, which advantageously allows IBM server 60 to operate in an interactive, real-time mode and to process XML-formatted transactions in a format that is native to the IBM server 60.

Beginning in step 710, a GMTP-formatted XML string is received from the integration point 160 of the server 50, discussed earlier. The XML string corresponds to an XML transaction or request, which is parsed by XML parser 715, called by step 710. Then, step 720 is invoked, wherein an XML transaction response is created using procedure 725. In step 730, the transaction type and format are retrieved from the XML string. In step 735, an API call to router program 235 is invoked. The router table 740 contains information indicating which program to call to handle the transaction, as well as parameter information. The table 740 could be stored using any known RDBMS system, such as IBM DB2.

In step 745, the router program 235 reads the transaction type and format of the transaction. Then, step 750 is invoked, wherein processing requirements 755 are retrieved from the DB2 database. In step 760, a handler program “X,” corresponding to a program capable of handling and processing the transaction, is invoked via an API call. After processing by the handler program X, step 765 is invoked, wherein a determination is made as to whether the last transaction as been processed. If a negative determination is made, step 745 is re-invoked, and the router program continues as discussed herein to process additional transactions. Importantly, the router program 235 continuously monitors handler program status during execution. When the handler program has terminated processing, control passes back to the router program.

In the event that a positive determination is made in step 765, step 775 is invoked, wherein an end of response transmission is written to the XML transaction response. Step 780 is also invoked, wherein code is written to end the GMTP XML response. In step 770, a determination is made as to whether a last transaction has been reached. If a negative determination is made, step 710 is invoked, so that additional GMTP-formatted XML transactions can be processed in accordance with the logic shown for program 700. If a positive determination is made, step 785 is invoked, wherein program 700 terminates.

FIG. 6 is a flowchart showing processing logic of the handler program 800 of the server program 200 of the IBM server 60 of the present invention in greater detail. As mentioned earlier, the router program 235 shown in FIG. 5 invokes one or more handler programs 800 (Program X) to handle the GMTP-formatted XML transaction processed by the router program. Program 800 corresponds to the handler program 260 shown in FIG. 2. Program 800 is invoked by an API call from GMTCGI program 700. In step 810, program 800 performs a PEEK operation to determine the transaction type and format. Then, in step 815, a GET operation is performed to retrieve status information from the transaction. Based on the transaction type, request type, and status information, program 800 then calls customizable subroutine 290.

Customizable subroutine 290 comprises a GET operation 820, custom code 275 for processing the transaction and, optionally, for calling one or more local or remote programs 280, and PUT operation 835. Customizable subroutine 290 performs an API call 270 to GET operation 820, which retrieves data fields from the GMTP-formatted XML string in step 825. Then, in step 830, data retrieved in step 825 is set into the fields of the data structure compatible with the server 60 and created by server program 200. In step 275, custom code written by a programmer, such as COBOL or RPG code, can be called, and one or more external programs 280 executed. For example, the programs 280 could comprise legacy payroll or accounting programs written in COBOL, RPG, or other languages. The results of execution are stored in the data structure compatible with the server 60. After execution of customized code, PUT operation 835 is invoked.

Customizable subroutine 290 invokes API call 285 to PUT operation 835, which retrieves results of execution stored in the data structure and in step 840, loads the data into the GMTP XML response created by GMTCGI program 700. Then, in step 845, the GMTP XML data is written to a standard output function, which, in step 850, sends the data to the integration point 160 for further processing. In step 855, processing of the XML transaction is complete, and the API call terminated.

As can be readily appreciated, the customizable subroutine 290 allows one or more legacy IBM server applications to operate in real-time mode to provide transaction processing of XML transactions in the externally described data structure that is native to the IBM server. Thus, XML transactions can be interactively handled by legacy code without requiring the need to re-code such applications. In this fashion, an enterprise can easily integrate existing IBM server programs for processing XML transactions in real time.

Having thus described the invention in detail, it is to be understood that the foregoing description is not intended to limit the spirit and scope thereof. What is desired to be protected by Letters Patent is set forth in the appended claims.

1. A method for processing e-commerce transactions on an IBM iSeries or AS/400 computer system comprising:
receiving an XML-formatted transaction at a central e-commerce website;
translating the XML-formatted transaction into an intermediate XML transport protocol;
dispatching the transaction to an IBM server;
parsing the transaction at the IBM server to determine a transaction type;
retrieving a handler program and a customizable subroutine on the IBM server based upon the transaction type; and
executing the transaction on the IBM server using the handler program and customizable subroutine.

2. The method of claim 1, further comprising processing the transaction at the e-commerce website according to one or more business rules.

3. The method of claim 2, wherein results of processing are stored in a database on the e-commerce website.

4. The method of claim 1, further comprising creating a data structure compatible with the IBM server.

5. The method of claim 4, further comprising loading contents of the transaction into the data structure.

6. The method of claim 5, further comprising passing the data structure to the customizable subroutine for execution.

7. The method of claim 6, further comprising executing one or more local or external applications using data in the data structure.

8. The method of claim 7, further comprising executing a COBOL or RPG program using data in the data structure.

9. The method of claim 7, further comprising storing results of execution in the data structure.

10. The method of claim 9, further comprising translating the results of execution stored in the data structure into one or more XML responses.

11. The method of claim 10, further comprising dispatching the one or more XML responses to a transaction requester via the e-commerce website.

12. The method of claim 1, further comprising selecting the handler program and customizable subroutine from a routing table.

13. A method for processing e-commerce transactions on an IBM iSeries or AS/400 computer system comprising:
providing an e-commerce website;
receiving XML transactions at the website;
converting the XML transactions into an intermediate protocol;
dispatching the XML transactions to an IBM server;
executing the XML transactions on the IBM server; and
transmitting results of processing to a requester via the e-commerce website.

14. The method of claim 13, further comprising translating the XML transactions into data structures compatible with the IBM server.

15. The method of claim 14, further comprising storing results of execution on the IBM server in the data structures.

16. The method of claim 15, further comprising translating results of execution stored in the data structures into XML responses.

17. The method of claim 16, further comprising transmitting the XML responses to a transaction requester via the e-commerce website.

18. The method of claim 13, further comprising executing one or more customizable subroutines to execute the XML transaction.

19. The method of claim 18, further comprising calling one or more local or external applications from the customizable subroutine.

20. The method of claim 19, further comprising calling one or more COBOL or RPG programs from the customizable subroutine.

21. A system for processing e-commerce transactions on an IBM iSeries or AS/400 computer system comprising:
an e-commerce website for receiving an XML transaction from a requester over the Internet, the e-commerce website including means for reformatting the XML transaction into an intermediate protocol format;
an IBM server in communication with the e-commerce website, the IBM server receiving the XML transaction from the e-commerce website;
means for executing the XML transaction on the IBM server; and
means for dispatching results of execution to a transaction requester.

22. The system of claim 21, wherein the means for executing the XML transaction comprises a server program for parsing the XML transaction to determine a transaction type.

23. The system of claim 22, wherein the means for executing the XML stores data in the XML transaction into a data structure compatible with the IBM server.

24. The system of claim 23, wherein the means for executing the XML transaction comprises means for routing the XML transaction to a handler program based upon the transaction type.

25. The system of claim 24, further comprising a customizable subroutine called by the handler program for executing the XML transaction using data stored in the data structure.

26. The system of claim 25, wherein the customizable subroutine calls one or more local or remote applications.

27. The system of claim 26, wherein the one or more local or remote applications comprise COBOL or RPG applications.

28. The system of claim 26, wherein the customizable subroutine stores results of execution in the data structure.

29. The system of claim 28, further comprising means for translating results of execution stored in the data structure into an XML response.

30. The system of claim 29, wherein the XML response is dispatched by the means for dispatching execution results via the e-commerce website.

31. A method for processing an XML transaction on a proprietary computing system comprising:
receiving an XML transaction at a central website;
transmitting the transaction to a proprietary computing system;
receiving the transaction at the proprietary computing system;
parsing the transaction on the proprietary computing system to determine a transaction type;
querying a router table using the transaction type;
retrieving a handler program from the router table based upon the transaction type;
executing the handler program;
calling a customizable subroutine from the handler program;
creating a data structure based upon the transaction type and compatible with the proprietary computing system;
loading data from the transaction into the data structure for execution by one or more local or remote applications;
executing the one or more local or remote applications from the customizable subroutine using data in the data structure;
storing results of execution in the data structure;
creating an XML response that includes the results of execution extracted from the data structure; and
passing the XML response to a transaction requester via the central website.

32. The method of claim 31, further comprising processing the XML transaction at the central website according to one or more business rules.

33. The method of claim 31, further comprising translating the XML transaction at the central website into an intermediate XML transport protocol prior to transmitting the transaction to the proprietary computing system.

34. The method of claim 31, wherein the step of executing the one or more local or remote applications comprises executing a COBOL or RPG application.
